(19) United States
(12) Patent Application Publication
(10) Pub. No.: US 2022/0282641 A1
(43) Pub. Date: Sep. 8, 2022

(54) CAM-FOLLOWER LUBRICATION SYSTEMS

(71) Applicant: CUMMINS INC., Columbus, IN (US)

(72) Inventors: Dilip Bhattacharjya, Warwickshire (GB); Yitong Chen, Buckinghamshire (GB); Owen Morris, Northants (GB); Robert Harries, Northamptonshire (GB); Matthew D. Brumberg, Scipio, IN (US); Ravishankar Hirisave, Greenwood, IN (US); Thomas Denne, Buckinghamshire (GB)

(73) Assignee: CUMMINS INC., Columbus, IN (US)

(21) Appl. No.: 17/751,315

(22) Filed: May 23, 2022

Related U.S. Application Data
(63) Continuation of application No. PCT/US2020/060962, filed on Nov. 18, 2020.
(60) Provisional application No. 62/939,764, filed on Nov. 25, 2019.

(51) Int. Cl. F01L 1/047; F16H 53/06; F01M 9/10

(52) U.S. Cl. CPC F01L 1/047; F16H 53/06; F01M 9/101; F01L 2810/02; F01L 2305/00

(57) ABSTRACT

A system comprises a follower lever and a follower roller rotatably coupled to the follower lever. A pin is rotatably coupled to the follower roller, the pin comprising a first outer portion including a first diameter and a second outer portion including a second diameter. A central portion is positioned between the first outer portion and the second outer portion, the central portion including a third diameter, the third diameter being smaller than the first diameter and the second diameter. One or more first channels is defined by the first outer portion, the one or more first channels positioned within the first outer portion and configured to direct fluid away from the central portion as the pin rotates.

### CROSS-REFERENCE TO RELATED APPLICATIONS

The present invention claims priority to U.S. Provisional Application No. 62/939,764, filed Nov. 25, 2019, the entire contents of which are incorporated herein.

### TECHNICAL FIELD

The present invention relates generally to systems for cam-follower lubrication systems in internal combustion engines.

### BACKGROUND

In an internal combustion engine, an intake valve opens and closes to control the introduction of air into a cylinder, and an exhaust valve opens and closes to control the release of combustion gases out of the cylinder. The timing of the intake and exhaust valves is controlled by a camshaft, which is rotatably coupled to the valves. The camshaft can be directly coupled to the valves, where cams on the camshaft contact the valves directly to control the opening and closing of the valves as the camshaft rotates. The camshaft can also be indirectly coupled to the valves, where the cams on the camshaft contact the valves indirectly (e.g., via a pushrod, lever, or other types of followers that contact the valves) to control the opening and closing of the valves as the camshaft rotates. Rotation of the camshaft and other camshaft follower components is aided by a lubricant (e.g., lubricant or other materials that reduce friction between surfaces) that reaches the rotating components via a lubricant flow path.

In some instances, foreign particles can enter the lubricant flow path of the follower during normal engine operation or when servicing the engine. When foreign particles enter the lubricant flow path of the follower, operation of the follower can be compromised when the foreign particles enter a concealed roller-pin interface, where there is no path to exit the interface. Particles in the roller-pin interface can block lubricant flow to the roller-pin interface, causing metal-to-metal contact that leads to premature failure. Particles in the roller-pin interface can also become entrapped, compromising the normal clearance between the roller and the pin. In either instance, foreign particles cause an increase in friction, causing rotation of the roller to be partially or fully restricted around the pin, which can subsequently lead to camshaft and follower damage by galling and spalling.

### SUMMARY

In one set of embodiments, a system comprises a follower lever and a follower roller rotatably coupled to the follower lever. A pin is rotatably coupled to the follower roller, the pin comprising a first outer portion including a first diameter and a second outer portion including a second diameter. A central portion is positioned between the first outer portion and the second outer portion, the central portion including a third diameter, the third diameter being smaller than the first diameter and the second diameter.

In another set of embodiments, a system comprises a follower lever and a follower roller rotatably coupled to the follower lever. The follower roller includes an inner surface defining an inner diameter and a first channel, the first channel extending into the inner surface and terminating at a first outlet and configured to direct a lubricant away from the inner surface. The follower roller also includes an outer surface defining an outer diameter, and a pin rotatably coupled to the follower roller and sized to fit within the inner diameter.

In yet another set of embodiments, a system comprises a follower lever and a follower shaft fluidly coupled to the follower lever. The follower shaft includes a lubricant supply channel extending from a lubricant inlet to a lubricant outlet and an insert positioned within the lubricant supply channel. The insert includes a first diverter coupled to the lubricant supply channel and extending toward the lubricant inlet and is configured to trap particles positioned within a lubricant flowing through the lubricant supply channel. A follower roller is rotatably coupled to the follower lever, and a pin is rotatably coupled to the follower roller.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIGS. 1-5 are illustrations of various views of a conventional cam follower assembly.

FIGS. 6-8 are illustrations of various views of a cam follower lever with a recessed lubricant groove, according to a particular embodiment.

FIGS. 9-10 are illustrations of various views of a push rod with a skirt, according to a particular embodiment.

FIGS. 11A-11B and 12 are illustrations of various views of a pin including multiple channels along an outer circumference, according to a particular embodiment.

FIGS. 13-14 are illustrations of various views of a pin including multiple channels along its length, according to a particular embodiment.

FIGS. 15-16 are illustrations of various views of a pin including a central channel, according to a particular embodiment.

FIG. 17 is an illustration of a pin including intersecting channels, according to a particular embodiment.

FIGS. 18-24 are illustrations of various views of a follower lever with a series of lubricant flow paths to a pin, according to a particular embodiment.

FIGS. 25-27 are illustrations of various views of a follower lever including an angled channel, according to a particular embodiment.

FIGS. 28-29, 30A-30B, and 31 are illustrations of various views of a follower lever including parallel lubricant channels, according to a particular embodiment.

FIGS. 32-34 are illustrations of various views of a follower lever with a vertical slot with a filtration device near the pushrod, according to a particular embodiment.

FIGS. 35-37 are illustrations of various views of a follower lever with an angled channel with a filtration device, according to a particular embodiment.

FIGS. 38-44 are illustrations of various views of another follower lever with a pressure relief valve, according to a particular embodiment.

FIGS. 45-46 are illustrations of various views of a follower roller with intersecting channels, according to a particular embodiment.

FIGS. 47-48 are illustrations of various views of a follower roller with equidistant channels, according to a particular embodiment.

FIG. 49 is an illustration of a follower roller with equidistant grooves on its inner diameter, according to a particular embodiment.

FIG. 50 is an illustration of a pin with a central channel, according to a particular embodiment.

FIG. 51 is an illustration of a follower lever with a system of intersecting channels, according to a particular embodiment.

FIGS. 52-54 are illustrations of various views of a follower shaft with an insert, according to a particular embodiment.

FIGS. 55-56 are illustrations of various views of a pin with an inlet lubricant supply path and an outlet, according to a particular embodiment.

FIGS. 57-58 are illustrations of various views another pin with an inlet lubricant supply path and an outlet, according to a particular embodiment.

FIGS. 59-64 are illustrations of various views of yet another pin with an inlet lubricant supply path and an outlet, according to a particular embodiment.

### DETAILED DESCRIPTION

Following below are more detailed descriptions of various concepts related to, and implementations of, methods, apparatuses, and systems for improving the robustness of cam-follower lubrication systems. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

In an internal combustion engine, an intake valve opens and closes to control the introduction of air into a cylinder, and an exhaust valve opens and closes to control the release of combusted fuel out of the cylinder. The timing of the intake and exhaust valves is controlled by a camshaft, which is rotatably coupled to the valves. The camshaft can be directly coupled to the valves, where the cams on the camshaft contact the valves directly to control the opening and closing of the valves as the camshaft rotates. The camshaft can also be indirectly coupled to the valves, where the cams on the camshaft contact the valves indirectly (e.g., via a pushrod, lever, or other type of follower that contacts the valves) to control the opening and closing of the valves as the camshaft rotates. Rotation of the camshaft and other camshaft follower components is aided by a lubricant (e.g., lubricant) that reaches the rotating components via a lubricant flow path.

Implementations herein relate to various systems to ensure sufficient lubricant is maintained in the lubricant flow path by either providing an outlet for the foreign particles to escape before causing damage, or by reducing the impact of the foreign particles by trapping the particles inside the assembly in a harmless manner. Addressing foreign particles in the lubricant flow path via the embodiments described herein can reduce failures due to foreign particles and extend the life of the camshaft and camshaft follower components.

### II. Conventional Cam Follower Assembly

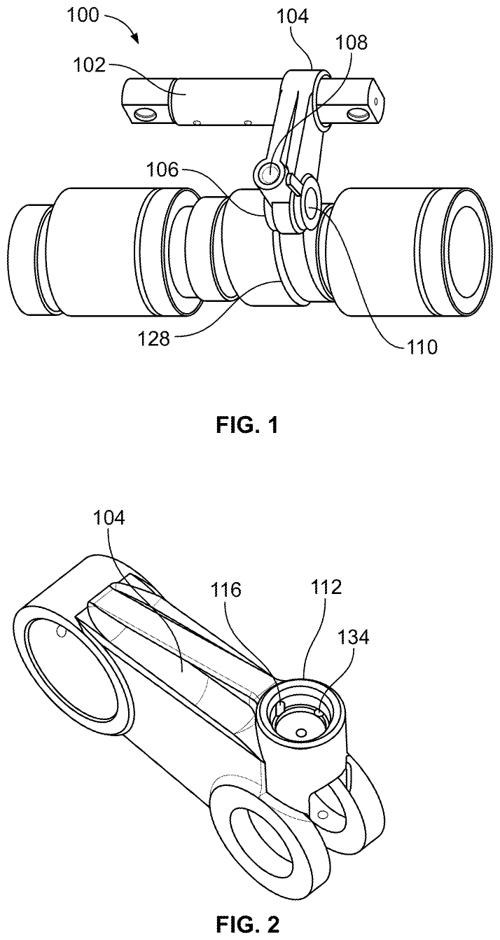

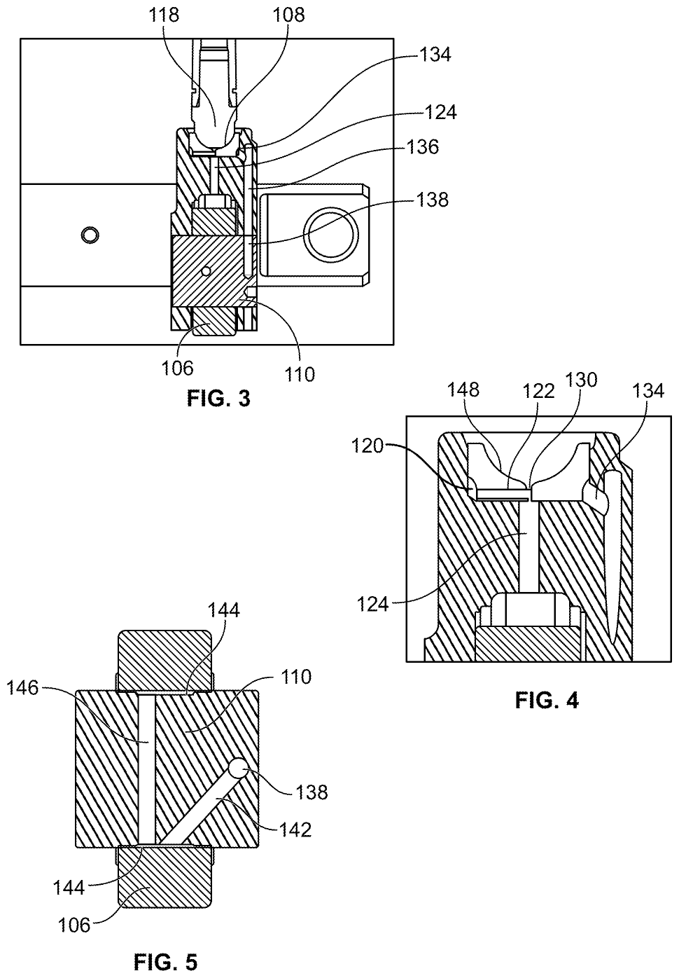

FIGS. 1-5 are illustrations of various views of a conventional cam follower assembly 100. The cam follower assembly 100 includes a cam follower shaft 102, a follower lever 104, a follower roller 106, a socket 108, and a pin 110. A lubricant flow path directs lubricant from the cam follower shaft 102 to a socket bore 112 in the follower lever 104 through a main channel that includes a main lubricant outlet 116. From the main lubricant outlet 116 in the socket bore 112, the lubricant flows into the socket 108, where push rods 118 are seated. From the socket bore 112, the lubricant flows around a void 120 between the socket 108 and the socket bore 112 and then separates into a first pathway and a second pathway. In the first pathway, the lubricant enters the socket 108 through a conduit 122 and splits into two additional feeds. A first feed 124 from the conduit 122 directs the lubricant to an outer face of the follower roller 106, providing lubricant to the follower roller 106 and a camshaft lobe interface 128. A second feed 130 from the conduit 122 directs the lubricant to a socket cup 148 to lubricate an interface between the socket 108 and the push rod 118. The second pathway from the socket bore 112 includes an angled conduit 134 positioned on the side of the follower lever 104, the angled conduit 134 coupled to a channel 136. The channel 136 directs lubricant to the lubricant inlet 138, positioned on the outer circumference of the pin 110. Once the lubricant flows into the pin 110 through the lubricant inlet 138, the lubricant is directed to a roller pin interface 144 via a conduit 142. The pin 110 includes a conduit 146 fluidly coupled to the roller pin interface 144 to supply lubricant to the other side of the pin and maintain lubricant flow across the roller-pin interface 144.

### III. Example Embodiments

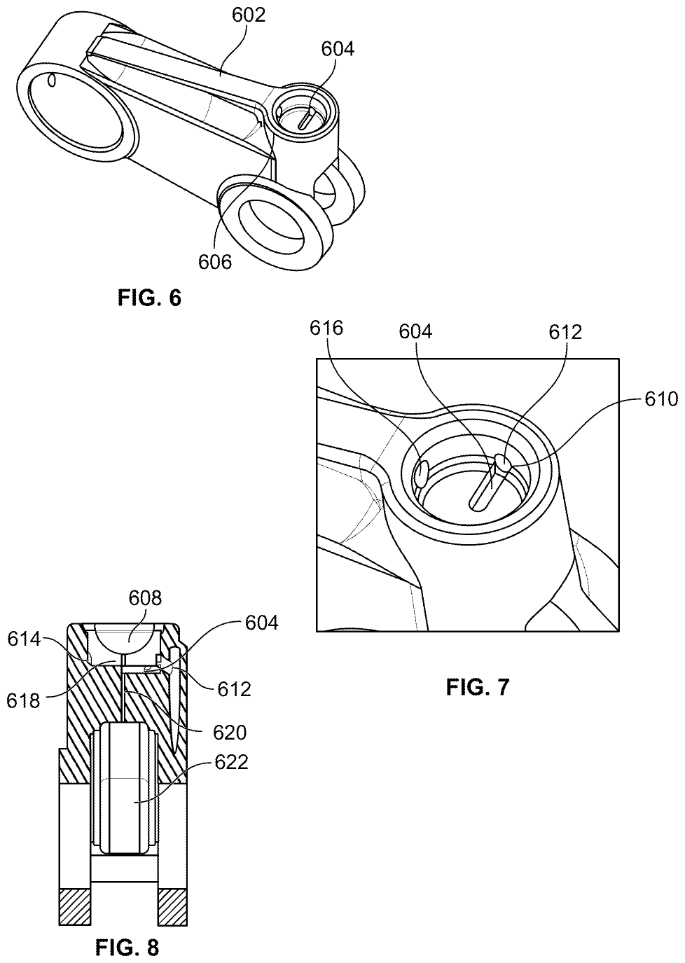

FIGS. 6-8 are illustrations of various views of a follower lever 602 with a recessed lubricant groove, according to a particular embodiment. The follower lever 602 includes a recessed lubricant groove 604 positioned in a bore 606 of a socket 608. A lip 610 at an end of the recessed lubricant groove 604 is used to prevent a foreign particle from entering a lubricant channel 612 positioned on an outer circumference of the bore 606. The main lubricant channel 616 is positioned within the outer circumference of the bore 606 approximately ninety degrees from the lubricant channel 612, and is vertically positioned within the bore 606 at a higher level than the lubricant channel 612. Accordingly, a foreign particle located in the recessed lubricant groove 604 is likely to exit the bore 606 via a vertical channel 618 or a vertical channel 620, where the vertical channel 618 is in fluid communication with the socket 608, and the vertical channel 620 is in fluid communication with a space 622, where the space 622 is configured to receive a roller. Generally, this concept is based on the principle of using the weight of the foreign particle and its propensity under gravity to fall into the recessed lubricant groove 604. With the addition of the lip 610 in fluid communication with the recessed lubricant groove 604, any foreign particle that is located in the groove has a higher propensity with the flow of lubricant to be directed as described instead of into the lubricant channel 612.

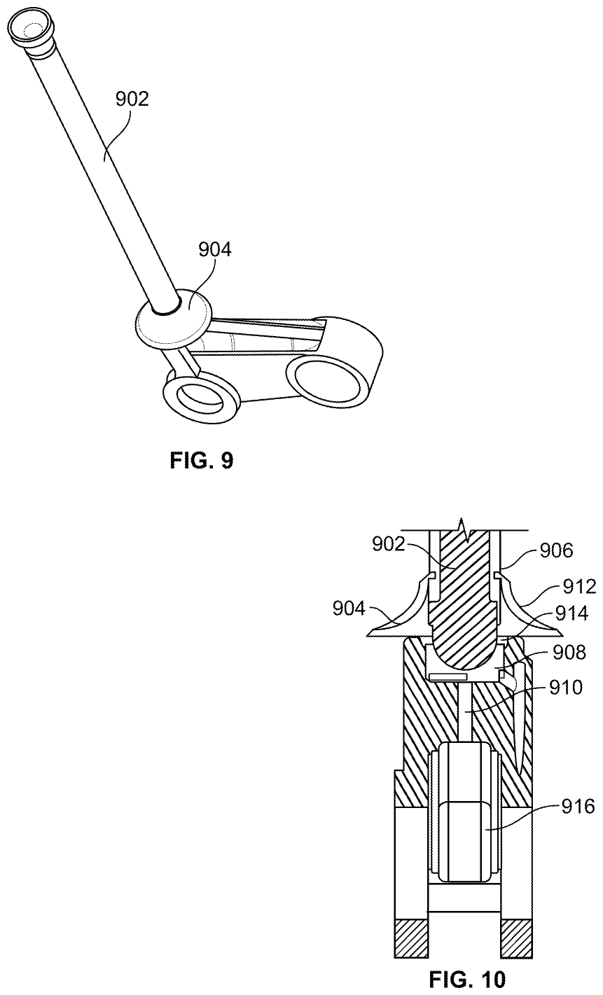

FIGS. 9-10 are illustrations of various views of a push rod 902 with a skirt 904, according to a particular embodiment. The skirt 904 is coupled to the pushrod 902 by inserting a lip of the skirt 904 into a groove 906 located around the outer circumference of the push rod 902. The skirt 904 is configured to prevent a foreign particle from intruding into a follower socket 908 during the operation of an engine. The skirt 904 includes a ramp portion 912 extending from the groove 906 to direct foreign particles away from a socket bore 914, thus preventing foreign particles from entering a vertical feed 910 extending between the socket 908 and a roller 916.

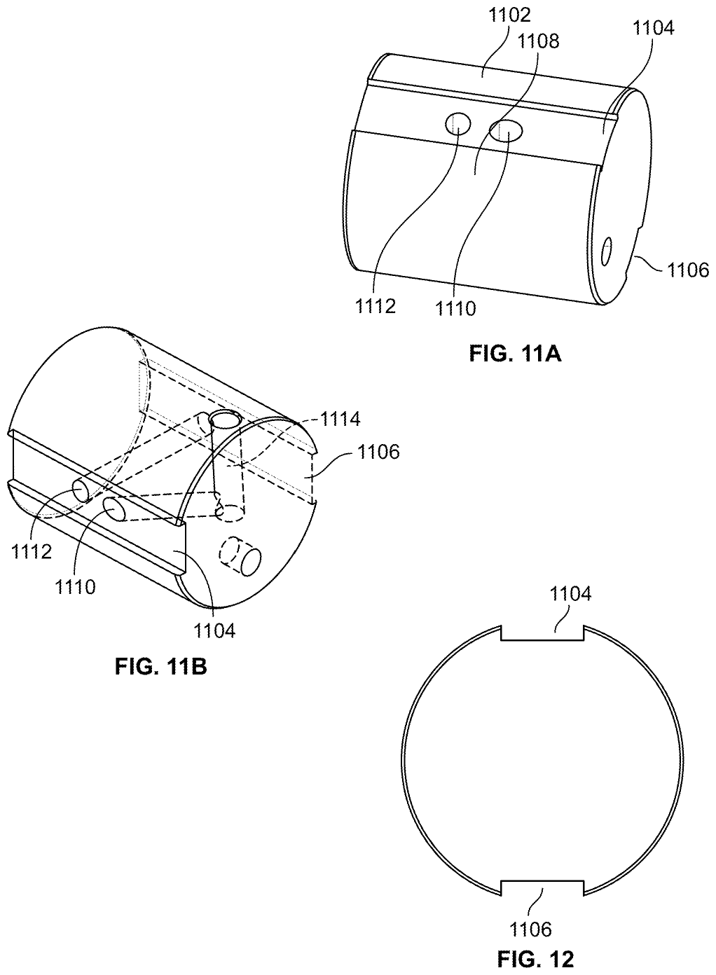

FIGS. 11-12 are illustrations of various views of a pin 1102 including multiple channels along an outer circumference, according to a particular embodiment. The pin 1102 is sized and configured to rotatably couple with a roller. The pin 1102 includes a first channel 1104 and a second channel 1106. The first channel 1104 and the second channel 1106 are recessed such that an outer diameter of the pin 1102 extends beyond bottom portions of the first channel 1104 and the second channel 1106. In some embodiments, the first channel 1104 and the second channel 1106 are positioned opposite each other across a diameter of the pin 1102 (e.g., approximately 180 degrees apart). The first channel 1104 and the second channel 1106 are also positioned so as to be approximately parallel with a longitudinal axis 1108 of the pin 1102.

The first channel 1104 includes a lubricant supply channel 1110 that is in fluid communication with a main lubricant supply 1114 such that lubricant reaches the pin 1102 and provides lubricant to an interface between the pin 1102 and a roller. The first channel 1104 also includes a lubricant distribution channel 1112 that extends from the first channel 1104 to the second channel 1106 such that lubricant in the first channel 1104 is directed toward the second channel 1106 via the lubricant distribution channel 1112.

In operation, the first channel 1104 and the second channel 1106 can direct a foreign particle away from the interface between the pin 1102 and the roller. For example, a foreign particle may enter the first channel 1104 via the lubricant supply channel 1110. The continuous lubricant flow from the lubricant supply channel 1110 causes lubricant to direct foreign particles along the first channel 1104 and the second channel 1106 and away from the interface between the pin 1102 and the roller.

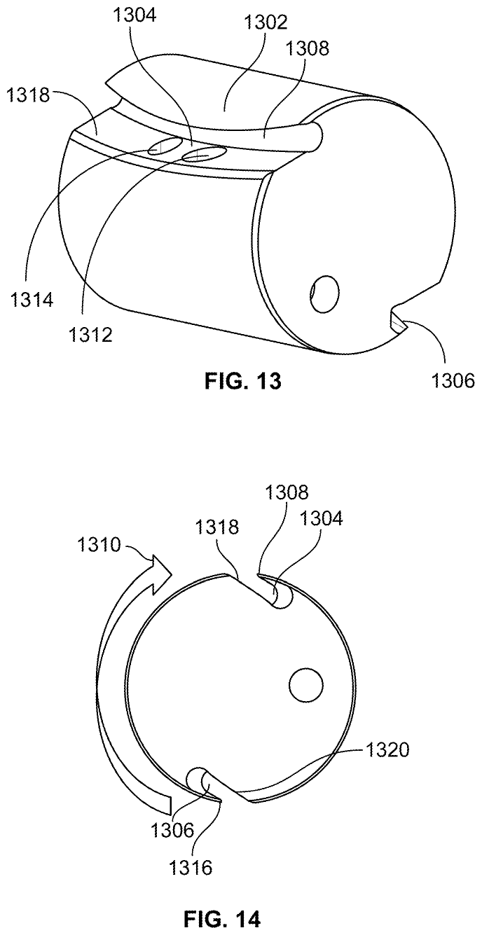

FIGS. 13-14 are illustrations of various views of a pin 1302 including multiple channels along its length, according to a particular embodiment. The pin 1302 is sized and configured to rotatably couple with a roller (for example, the roller 106). A first channel 1304 is positioned on an outer portion of the pin 1302 and extends into the surface of the pin 1302 such that a first base 1318 of the first channel 1304 is substantially parallel to a longitudinal axis of the pin 1302. A first overhang 1308 is positioned opposite the first base 1318 such that the first overhang 1308 and the first base 1318 define the first channel 1304. The first overhang 1308 is curved such that a central portion of the first overhang 1308 extends over the first base 1318 farther than a first side portion of the first overhang 1308 or a second side portion of the first overhang 1308. The pin 1302 is configured to fit within a roller, and the roller rotates in the direction indicated by the arrow 1310 during operation of the engine.

A second channel 1306 is positioned on an outer portion of the pin 1302 and extends into the surface of the pin 1302 such that a second base 1320 of the second channel 1306 is substantially parallel to the longitudinal axis of the pin 1302. A second overhang 1316 is positioned opposite the second base 1320 such that the second overhang 1316 and the second base 1320 define the second channel 1306. The second overhang 1316 is curved such that a central portion of the second overhang 1316 extends over the second base 1320 farther than a first side portion of the second overhang 1316 or a second side portion of the second overhang 1316.

The first channel 1304 includes a lubricant supply channel 1312 such that lubricant reaches the pin 1302 from a lubricant source (e.g., from a follower lever) and provides lubricant to an interface between the pin 1302 and a roller. The first channel 1304 also includes a lubricant distribution channel 1314 that extends from the first channel 1304 to the second channel 1306 such that lubricant in the first channel 1304 is directed toward the second channel 1306 via the lubricant distribution channel 1314.

In operation, the first channel 1304 and the second channel 1306 can direct a foreign particle away from the interface between the pin 1302 and the roller. For example, a foreign particle may enter the first channel 1304 via the lubricant supply channel 1312. The continuous lubricant flow from the lubricant supply channel 1312 and the curved shape of the first channel 1304 and the second channel 1306 causes lubricant to direct foreign particles along the first channel 1304 and the second channel 1306 and away from the interface between the pin 1302 and the roller. In addition, the first overhang 1308 and the second overhang 1316 can direct foreign particles from the interface between the pin 1302 and the roller into the first channel 1304 or the second channel 1306 to direct the foreign particles away from the interface.

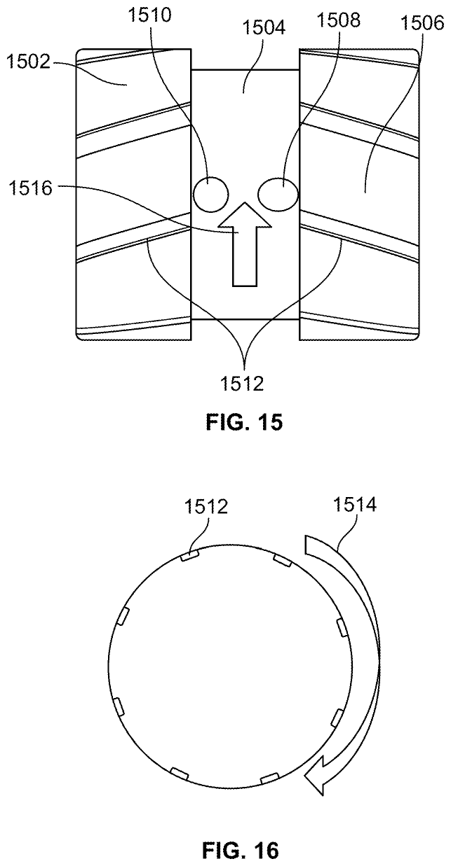

FIGS. 15-16 are illustrations of various views of a pin 1502 including a central channel 1504, according to a particular embodiment. The pin 1502 is sized and configured to rotatably couple with a roller (for example, the roller 106). A central portion of the pin 1502 is disposed between a first outer portion and a second outer portion, and defines the central channel 1504. The central channel 1504 extends around an outer circumference of the pin 1502 such that a longitudinal axis of the central channel 1504 is the same as a central axis 1506 of the pin 1502. The central channel 1504 is recessed such that an outer diameter of the pin 1502 extends beyond an outer diameter of the central channel 1504. The central channel 1504 includes a lubricant supply channel 1508 that supplies lubricant to an interface between the pin 1502 and a roller. The central channel 1504 also includes a lubricant distribution channel 1510 that extends through the central channel 1504 perpendicular to the central axis 1506. Lubricant from the lubricant supply channel 1508 is directed through the lubricant distribution channel 1510 such that lubricant is provided from both ends of the lubricant distribution channel 1510.

The pin 1502 also includes a plurality of secondary channels 1512 positioned on the outer circumference of the pin 1502 and extending from the central channel 1504 to an outer edge of the pin 1502. Accordingly, each of secondary channels 1512 provides a conduit along which lubricant can flow. The secondary channels 1512 are positioned so as to direct lubricant away from the central channel 1504 as a roller rotates around the pin 1502 in the direction of the arrow 1514.

In operation, a foreign particle that enters the central channel 1504 from the lubricant supply channel 1508 is directed toward one of the plurality of secondary channels 1512 by the flow of the lubricant. When the foreign particle enters one of the plurality of secondary channels 1512, the rotation of the roller directs the lubricant, and thus the foreign particle, away from an interface between the pin 1502 and the roller.

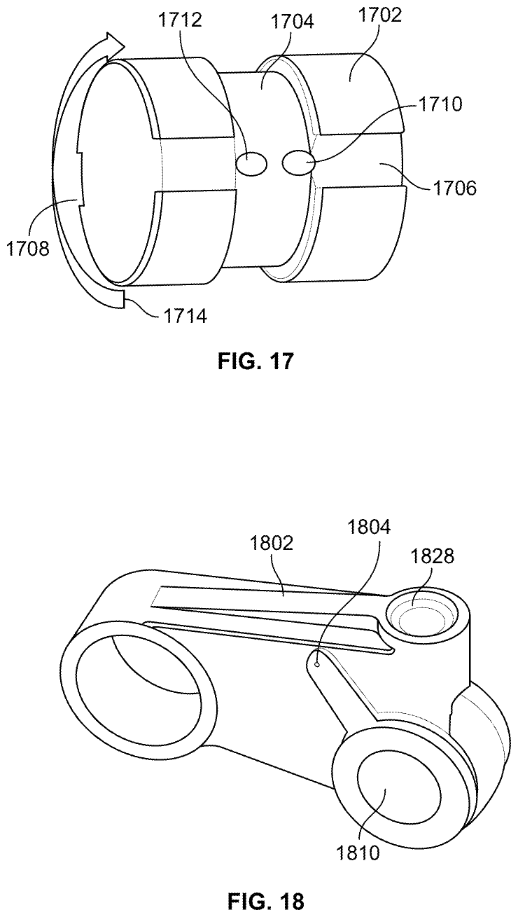

FIG. 17 is an illustration of a pin 1702 including intersecting channels, according to a particular embodiment. The pin 1702 is sized and configured to rotatably couple with a roller (for example, the roller 106). A central portion of the pin 1702 is disposed between a first outer portion and a second outer portion, and defines a central channel 1704. The central channel 1704 extends around an outer circumference of the pin 1702 such that a longitudinal axis of the central channel 1704 is the same as a longitudinal axis of the pin 1702. The central channel 1704 is recessed such that an outer diameter of the pin 1702 extends beyond an outer diameter of the central channel 1704. The central channel 1704 includes a lubricant supply channel 1710 that supplies lubricant to an interface between the pin 1702 and a roller. The central channel 1704 also includes a lubricant distribution channel 1712 that extends through the central channel 1704 perpendicular to the longitudinal axis of the pin 1702. Lubricant from the lubricant supply channel 1710 is directed through the lubricant distribution channel 1712 such that lubricant is provided from both ends of the lubricant distribution channel 1712 to the interface between the pin 1702 and the roller.

The pin 1702 also includes a first channel 1706 and a second channel 1708. The first channel 1706 and the second channel 1708 are recessed such that an outer diameter of the pin 1702 extends beyond the bottom portions of the first channel 1706 and the second channel 1708. In some embodiments, the first channel 1706 and the second channel 1708 are positioned opposite each other across a diameter of the pin 1702 (e.g., approximately 180 degrees apart). The first channel 1706 and the second channel 1708 are also positioned so as to be approximately parallel with the longitudinal axis of the pin 1702. The first channel 1706 and the second channel 1708 are also positioned so as to intersect the central channel 1704.

In operation, foreign particles may enter the central channel 1704 via the lubricant supply channel 1710. The rotation of a roller around the pin 1702 in the direction of the arrow 1714 maintains the foreign particle in the central channel 1704, preventing the foreign particle from reaching an interface between the pin 1702 and a roller. The rotation of the roller around the pin 1702 may also direct foreign particles toward the first channel 1706 and the second channel 1708, and the rotation of the pin 1702 further directs foreign particles within the first channel 1706 and the second channel 1708 away from the central channel 1704 and toward either end of the pin 1702, thereby preventing the foreign particles from entering the interface between the pin 1702 and the roller.

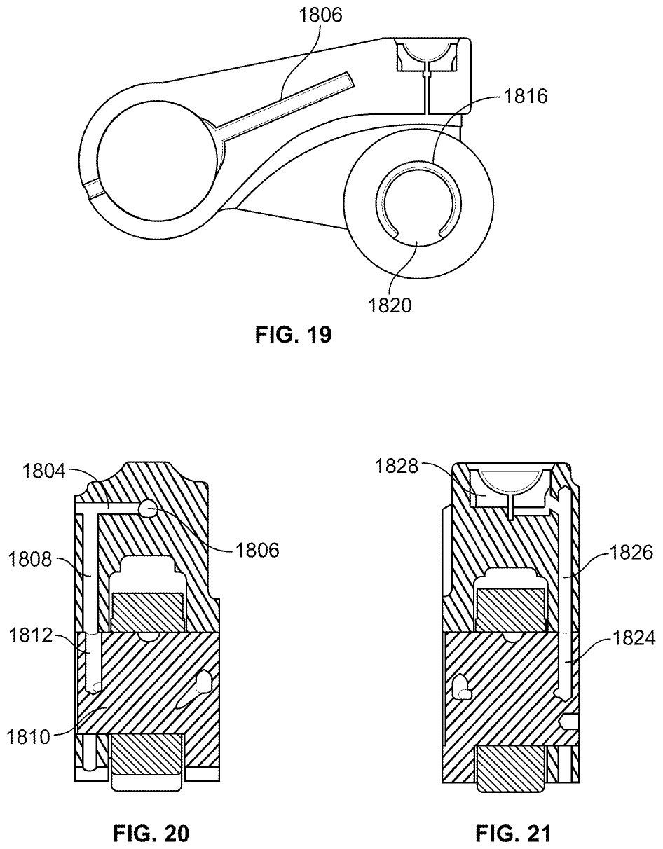

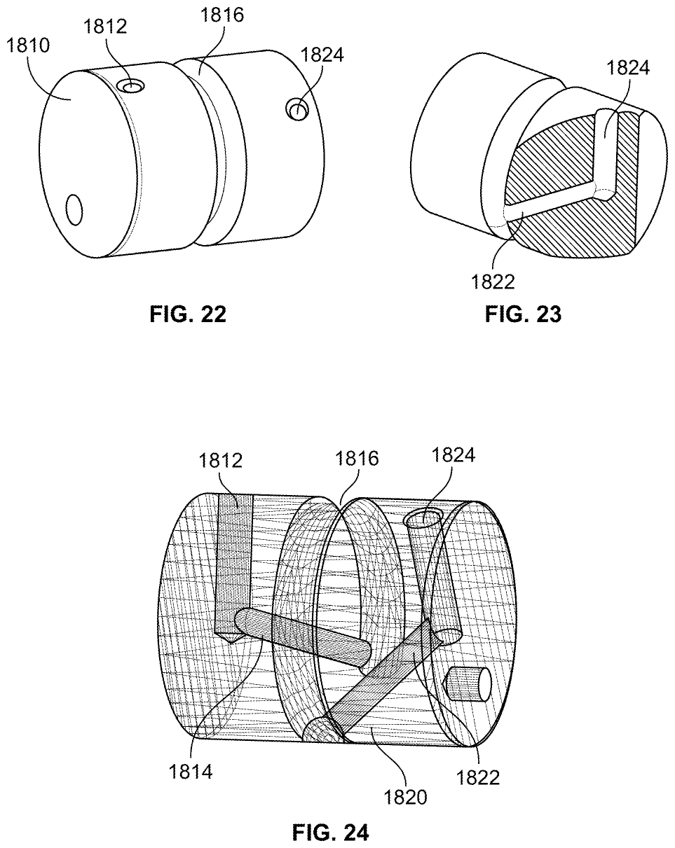

FIGS. 18-24 are illustrations of various views of a follower lever assembly 1802 with a series of lubricant flow paths to a pin 1810, according to a particular embodiment. The follower lever assembly 1802 includes a lubricant supply 1806 extending from a follower shaft (not shown) into the follower lever assembly 1802. The lubricant supply 1806 directs lubricant to a channel 1804, which directs lubricant through a passage 1808 and into a lubricant inlet 1812 located within the pin 1810. Lubricant flows from the lubricant inlet 1812 into a first angled passage 1814 and then to a central channel 1816 positioned around the circumference of the pin 1810. In some embodiments, the central channel 1816 extends entirely around the pin 1810. The central channel 1816 is a recessed portion of the pin 1810 that provides a space for the lubricant. In some embodiments, the central channel 1816 extends partially around the pin 1810 such that an unmachined portion 1820 is positioned between a first endpoint of the central channel 1816 and a second endpoint of the central channel 1816. The unmachined portion 1820 provides for a consistent bearing contact area (e.g., hydrodynamic film thickness) between the pin 1810 and a roller.

The lubricant flows from the central channel 1816 to a second angled passage 1822, and the second angled passage 1822 directs the lubricant to a lubricant outlet 1824 that directs the lubricant to a return feed 1826 located in the follower lever assembly 1802. The return feed 1826 directs the lubricant to a socket 1828 and the roller.

In operation, foreign particles that enter the lubricant are directed along the lubricant flow path as described such that the foreign particles are deposited on to an outer circumference of the roller. Depositing foreign particles in such a position reduces the risk of the foreign particles damaging the components. Furthermore, the embodiment described provides for higher lubricant pressure at an interface between the pin 1810 and the roller, which aids in directing the foreign particles to the desired location.

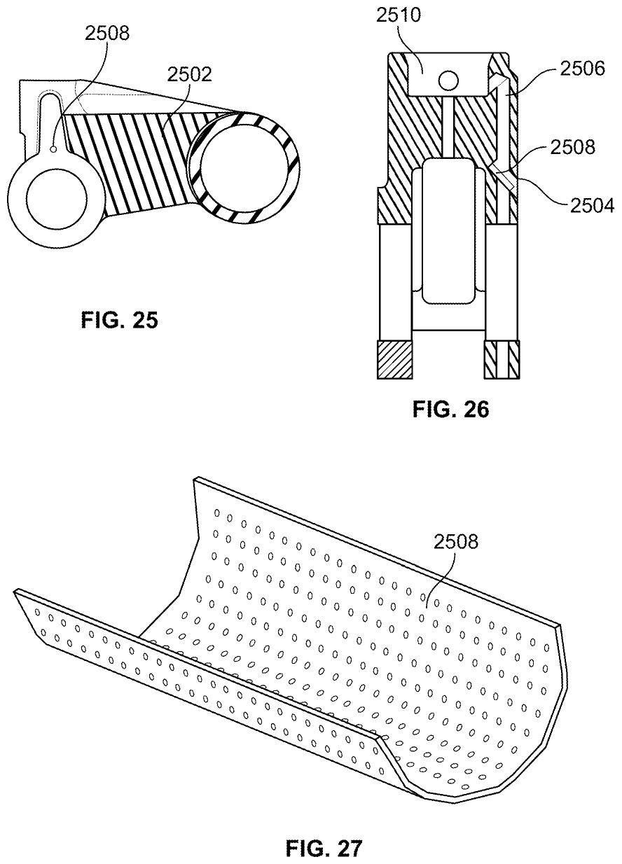

FIGS. 25-27 are illustrations of various views of a follower lever 2502 including an angled channel 2504, according to a particular embodiment. The follower lever 2502 includes a channel 2506 configured to direct lubricant from a pin (not shown) to a socket 2510. The channel 2506 intersects the angled channel 2504, and the angled channel 2504 is positioned to direct foreign particles away from the follower lever 2502. The angled channel 2504 includes a mesh 2508 disposed within the angled channel 2504 and positioned around an inner diameter of the angled channel 2504. In some arrangements, the mesh 2508 is manufactured from stainless steel. In other arrangements, the mesh 2508 is manufactured from other materials suitable for use in a follower lever (e.g., aluminum, titanium, etc.). The mesh 2508 includes a plurality of openings sized to allow lubricant to pass through and to capture foreign particles and prevent the foreign particles from passing through. In some specific implementations, the plurality of openings are approximately thirty microns. Accordingly, foreign particles located in the lubricant within the channel 2506 will be captured by the mesh 2508, and the angled channel 2504 directs the foreign particles away from the follower lever 2502.

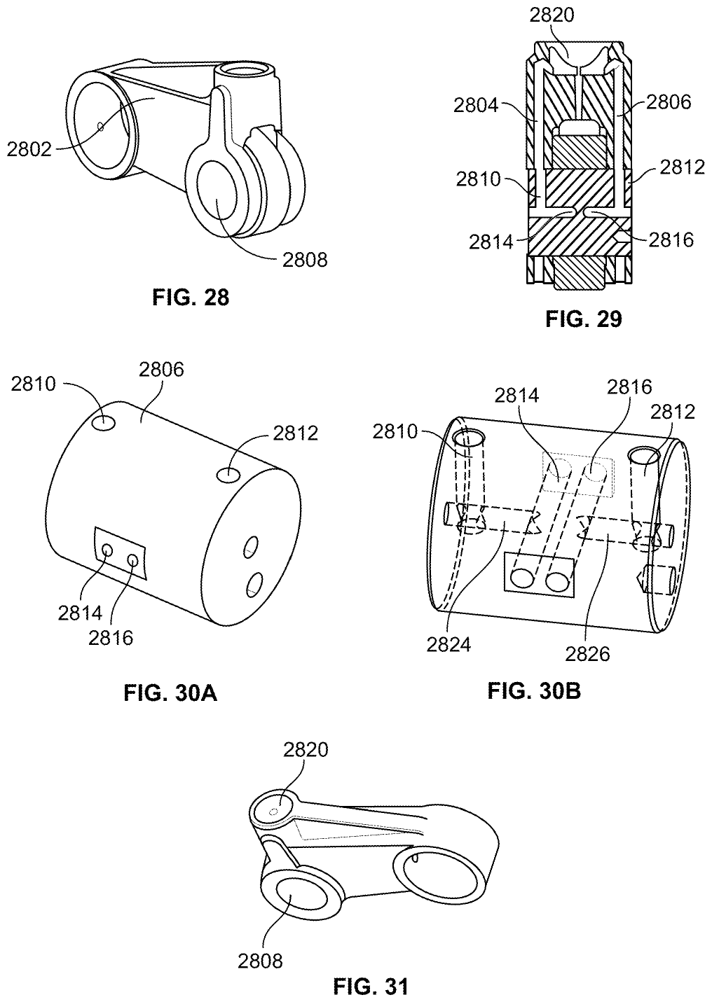

FIGS. 28-31 are illustrations of various views of a follower lever assembly 2802 including parallel lubricant channels, according to a particular embodiment. The follower lever assembly 2802 includes a first lubricant supply channel 2804 and a second lubricant supply channel 2806, where the first lubricant supply channel 2804 is positioned opposite the second lubricant supply channel 2806, with a socket 2820 and a pin 2808 positioned in between the first lubricant supply channel 2804 and the second lubricant supply channel 2806.

The first lubricant supply channel 2804 directs lubricant to a first lubricant feed 2810 positioned in the pin 2808. The first lubricant feed 2810 directs lubricant to a first lubricant passage 2814 via a first cross passage 2824, and the first lubricant passage 2814 directs the lubricant to an interface between the pin 2808 and a roller such that the interface is lubricated. The second lubricant supply channel 2806 directs the lubricant to a second lubricant feed 2812 positioned in the pin 2808. The second lubricant feed 2812 directs the lubricant to a second lubricant passage 2816 via a second cross passage 2826, and the second lubricant passage 2816 directs the lubricant to the interface between the pin 2808 and the roller such that the interface is lubricated.

In operation, the first lubricant supply channel 2804 and the second lubricant supply channel 2806 provide a redundant supply of lubricant to the pin 2808. The redundant supply of lubricant mitigates the risk of foreign particles entering the lubricant flow path. For example, foreign particles may enter the lubricant flow path in the first lubricant supply channel 2804, and the foreign particles may significantly impact the ability of the lubricant to reach the pin 2808 to provide for proper lubrication. In such an instance, the supply of lubricant from the second lubricant supply channel 2806 supplies the lubricant necessary to lubricate the interface between the pin 2808 and the roller.

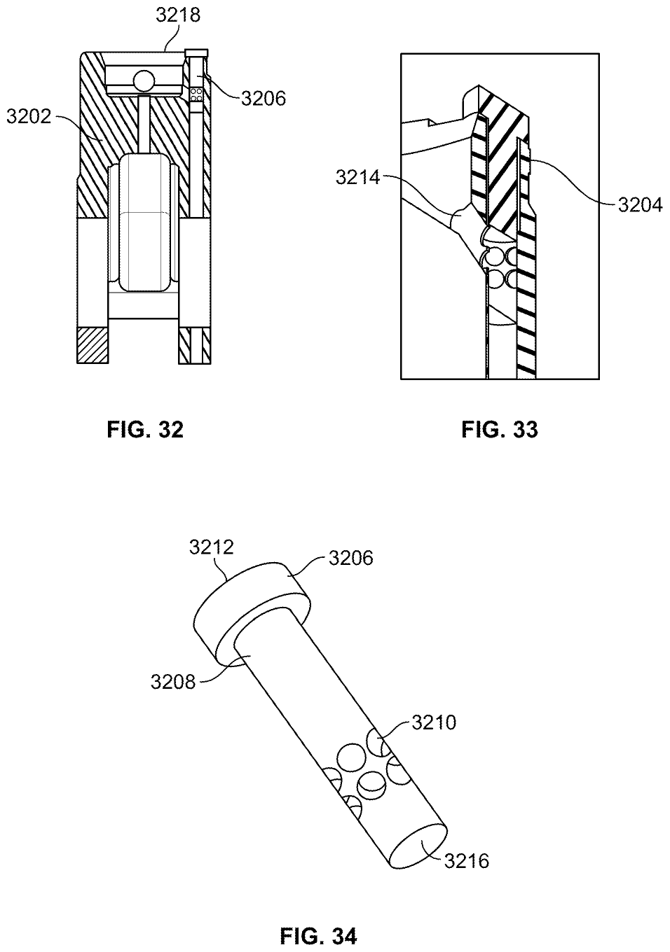

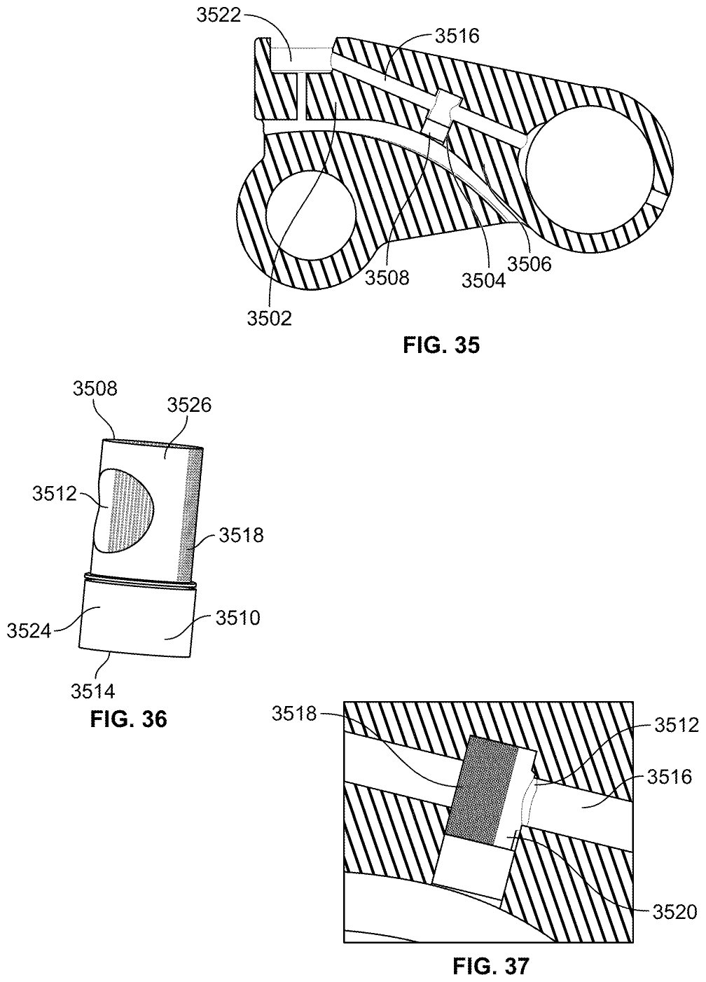

FIGS. 32-34 are illustrations of various views of a follower lever 3202 with a vertical slot 3204 with a filtration device 3206, according to a particular embodiment. The vertical slot 3204 is positioned adjacent to a socket 3218 and is in fluid communication with a lubricant supply channel 3214, where lubricant flows from the socket 3218 to the lubricant supply channel 3214. The filtration device 3206 is sized and configured to fit within the vertical slot 3204. The filter device 3206 includes a top portion 3212 and a bottom portion 3208. The top portion 3212 includes features to provide for installation and removal of the filtration device 3206 (e.g., the top portion 3212 is configured to receive a screwdriver, wrench, or other tool to install or remove the filtration device 3206). The bottom portion 3208 is threaded and the threads are configured to be received by corresponding threads on an inner diameter of the vertical slot 3204. The bottom portion also includes a plurality of apertures 3210 and a mesh 3216. The plurality of apertures are sized and configured to allow lubricant to flow from the lubricant supply channel 3214. In some particular implementations, the apertures are approximately three millimeters in diameter with an acceptable tolerance (e.g., 0.2 mm, 0.5 mm, 0.8 mm, etc.). The mesh 3216 is sized and configured to allow lubricant to flow through the filtration device 3206 but prevent foreign particles from flowing through the filter device 3206. For example, the mesh 3216 can include openings of approximately thirty microns. Accordingly, lubricant free of foreign particles flows to a pin such that the interface between the pin and a roller is properly lubricated. The filtration device 3206 is configured to be replaced or serviced by removing the filtration device 3206 from the vertical slot 3204 during routine maintenance operations.

FIGS. 35-37 are illustrations of various views of a follower lever 3502 with an angled channel 3504, according to a particular embodiment. The follower lever 3502 includes a follower body 3506 and a lubricant supply channel 3516. The lubricant supply channel 3516 extends through the follower body 3506 and is in fluid communication with a socket 3522 such that lubricant is directed toward the socket 3522 by the lubricant supply channel 3516. The follower body 3506 includes the angled channel 3504, which intersects the lubricant supply channel 3516. The angled channel 3504 is sized and configured to receive a filter device 3508.

The filter device 3508 includes a bottom portion 3524 and a top portion 3526. The bottom portion 3524 includes a threaded portion 3510 and a bottom surface 3514. The threaded portion 3510 includes threads or other connection surfaces configured to interface with corresponding surfaces on an inner diameter of the angled channel 3504. The bottom surface 3514 includes features to provide for installation and removal of the filter device 3508 (e.g., the bottom surface 3514 is configured to receive a screwdriver, wrench, or other tool to install or remove the filter device 3508). The top portion 3526 includes an aperture 3512 and a mesh 3518. The aperture 3512 is configured to be aligned with the lubricant supply channel 3516 when the filter device 3508 is assembled to the follower lever 3502 such that the lubricant flows through the aperture 3512. The mesh 3518 is sized and configured to allow lubricant to flow through the filter device 3508 but prevent foreign particles from flowing through the filter device 3508. In some particular implementations, the apertures are approximately three millimeters in diameter with an acceptable tolerance (e.g., 0.2 mm, 0.5 mm, 0.8 mm, etc.). Accordingly, lubricant free of foreign particles flows to the socket 3522 such that the components are properly lubricated. For example, the mesh 3216 can include openings of approximately thirty microns. The filter device 3508 is configured to be replaced or serviced by removing the filter device 3508 from the angled channel 3504 during routine maintenance operations.

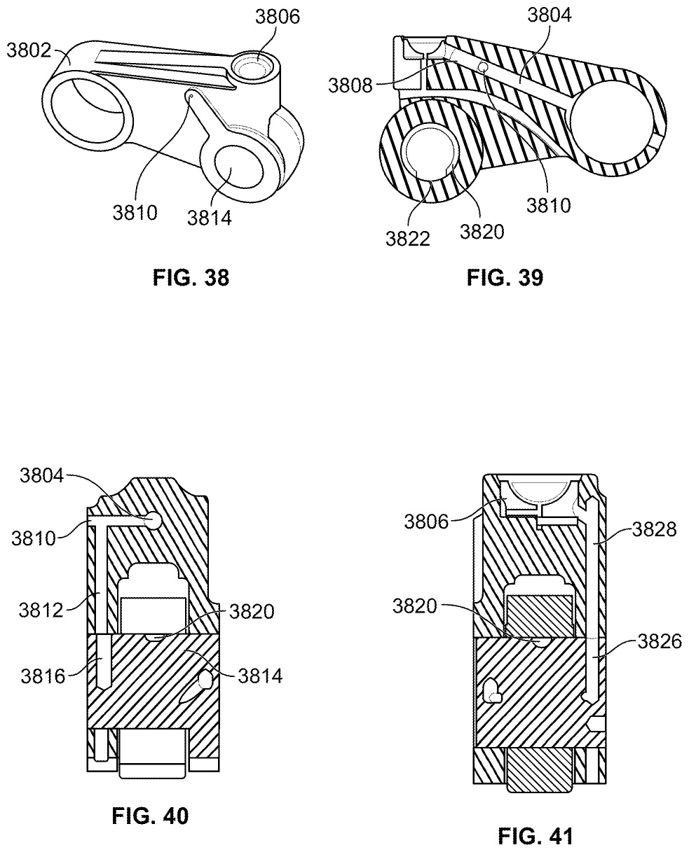

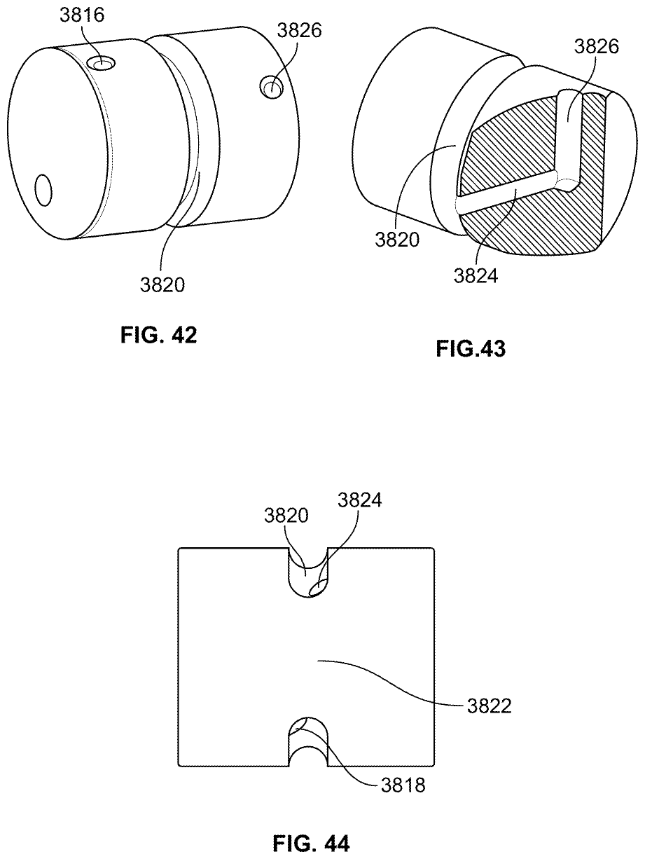

FIGS. 38-44 are illustrations of various views of a follower lever assembly 3802 with a pressure relief valve 3808, according to a particular embodiment. The follower lever assembly 3802 includes a main lubricant channel 3804 in fluid communication with a socket 3806. The pressure relief valve 3808 is positioned within the main lubricant channel 3804 and is configured to be open or closed. In the open position, the pressure relief valve 3808 allows lubricant to flow from the main lubricant channel 3804 to the socket 3806. In the closed position, the pressure relief valve 3808 prevents lubricant from flowing to the socket 3806 and instead directs lubricant into a side channel 3810. The side channel 3810 directs the lubricant to a supply passage 3812, which in turn directs the lubricant to a pin 3814 via an inlet channel 3816. The lubricant flows through the inlet channel 3816 and into an inlet cross channel 3818 that directs the lubricant to a central channel 3820.

The central channel 3820 extends partially around the circumference of the pin 3814 and is recessed such that a base of the central channel 3820 is below the surface of the outer diameter of the pin 3814. The portion of the pin that does not include the central channel is an unmachined portion 3822. The unmachined portion 3822 provides for more contact area between the pin 3814 and a roller (not shown) than if the central channel 3820 extended entirely around the pin 3814, and provides for higher lubricant pressure at an interface between the pin 3814 and the roller. The central channel 3820 extends around the pin 3814 and intersects an outlet cross channel 3824 such that the lubricant is directed around the central channel 3820 and into the outlet cross channel 3824. The outlet cross channel 3824 is in fluid communication with an outlet channel 3826 that directs the lubricant to a return passage 3828, which directs the lubricant to the socket 3806.

In operation, when the pressure relief valve 3808 is in the closed position, the lubricant flow is directed such that foreign particles that may be present in the lubricant are directed to lower risk areas (e.g., an outer circumference of the roller) by the lubricant flow path and the higher lubricant pressure as described. In some embodiments, foreign particles in the lubricant may cause the lubricant to flow slowly or stop entirely, thereby increasing the pressure of the lubricant. In such embodiments, the pressure relief valve opens in response to the increasing pressure, allowing lubricant to flow to the socket 3806, and then to the pin 3814, thereby providing adequate lubrication to maintain operation of the follower lever assembly 3802.

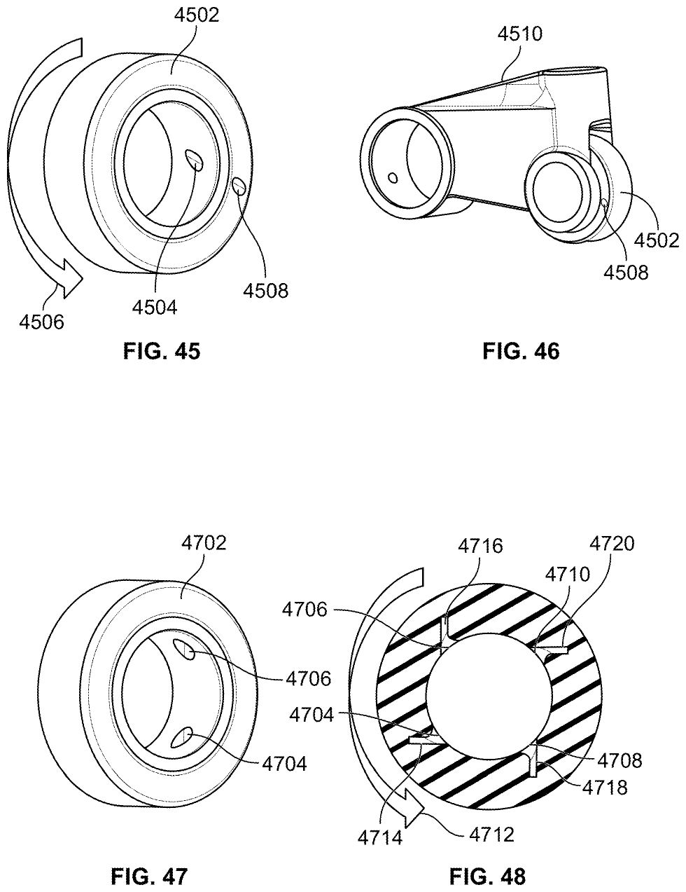

FIGS. 45-46 are illustrations of various views of a cam roller 4502, according to a particular embodiment. The cam roller 4502 includes an inlet 4504 positioned on an inner diameter of the cam roller 4502. A channel extends between the inlet 4504 and an outlet 4508 positioned on an outer surface of the cam roller 4502. The channel is configured to direct foreign particles away from the cam roller 4502 as the cam roller 4502 rotates in the direction of the arrow 4506 (e.g., the centrifugal force of rotation of the cam roller 4502 forces the foreign particles toward the inner diameter of the cam roller 4502 and into the inlet 4504). When the foreign particles reach the outlet 4508, the foreign particles are removed from the lubricant path.

FIGS. 47-48 are illustrations of various views of a follower roller 4702 with channels, according to a particular embodiment. As shown, the follower roller 4702 includes a first inlet 4704, a second inlet 4706, a third inlet 4708, and a fourth inlet 4710 (collectively referred to herein as “inlets 4704-4710”). In some embodiments, the follower roller may include more (e.g., five or more) inlets. The inlets 4704-4710 are located on an inner diameter of the follower roller 4702 and are positioned such that the inlets 4704-4710 are spaced around the inner diameter of the follower roller 4702. Each of the inlets 4704-4710 includes a corresponding channel. For example, the first inlet 4704 includes a first channel 4714, the second inlet 4706 includes a second channel 4716, the third inlet 4708 includes a third channel 4718, and the fourth inlet 4710 includes a fourth channel 4720. The first channel 4714, the second channel 4716, the third channel 4718, and the fourth channel 4720 are collectively referred to herein as “the channels 4714-4720.” The channels 4714-4720 extend from the corresponding inlets 4704-4710 such that the channels 4714-4720 extend into an inner surface of the follower roller 4702. As the follower roller 4702 rotates in the direction of the arrow 4712, foreign particles located in lubricant adjacent to the inner diameter of the follower roller 4702 are directed into the inlets 4704-4714 by the centrifugal force of rotation of the follower roller 4702. The foreign particles are further directed into the channels 4714-4720, thereby removing the foreign particles from the lubricant.

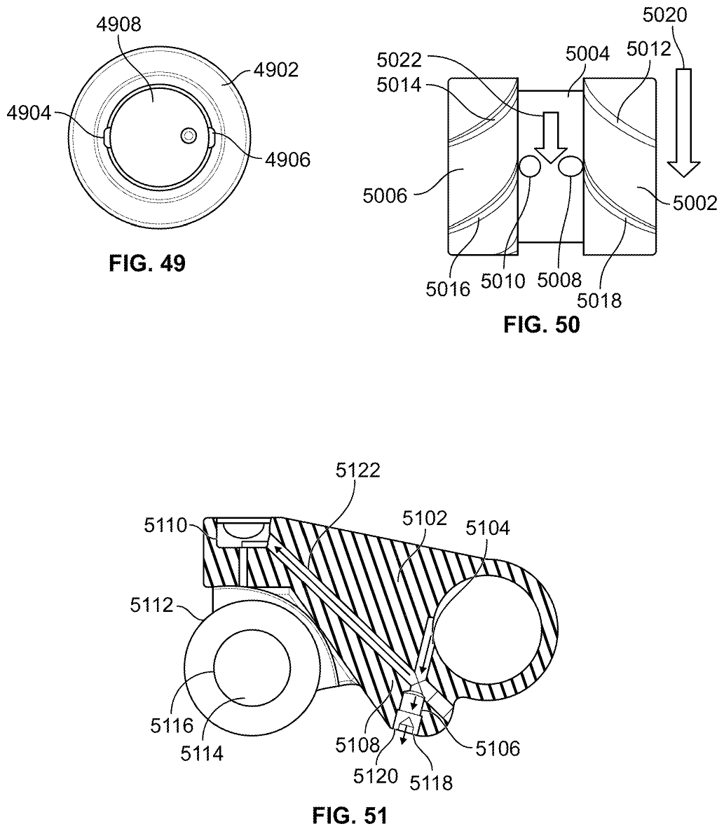

FIG. 49 is an illustration of a follower roller 4902 with grooves on its inner diameter, according to a particular embodiment. The follower roller 4902 includes a first groove 4904 and a second groove 4906 (collectively referred to herein as “grooves 4906-4906”). As shown, the follower roller 4902 includes two grooves; however, in some embodiments the follower roller 4902 can include more or fewer grooves. The grooves 4904-4906 are recesses located on an inner diameter of the follower roller 4902 and extend across the entire follower roller 4902. The grooves 4904-4906 are positioned such that the grooves 4904-4906 are equally spaced around the inner diameter of the follower roller 4902. As the follower roller 4902 rotates around a pin 4908, the centrifugal force of rotation forces any foreign bodies located in the lubricant toward the grooves 4904-4906, and from the grooves 4904-4906 the foreign bodies are removed from the follower roller 4902.

FIG. 50 is an illustration of a pin 5002 with a central channel 5004, according to a particular embodiment. A central portion of the pin 5002 is disposed between a first outer portion and a second outer portion, and defines the central channel 5004. The central channel 5004 extends around an outer circumference of the pin 5002 such that a longitudinal axis of the central channel 5004 is the same as a central axis 5006 of the pin 5002. The central channel 5004 is recessed such that an outer diameter of the pin 5002 extends beyond an outer diameter of the central channel 5004. The central channel 5004 includes a lubricant supply channel 5008 that supplies lubricant to an interface between the pin 5002 and a roller. The central channel 5004 also includes a lubricant distribution channel 5010 that extends through the central channel 5004 perpendicular to the central axis 5006. Lubricant from the lubricant supply channel 5008 is directed through the lubricant distribution channel 5010 such that lubricant is provided to the pin 5002 from both ends of the lubricant distribution channel 5010.

The pin 5002 also includes a plurality of curved channels (e.g., a first curved channel 5012, a second curved channel 5014, a third curved channel 5016, and a fourth curved channel 5018) positioned on the outer circumference of the pin 5002 and extending from the central channel 5004 to an outer edge of the pin 5002. Accordingly, each of the curved channels 5012-5018 provides a conduit along which lubricant can flow. The curved channels 5012-5018 are shaped and positioned so as to direct lubricant away from the central channel 5004 as the pin 5002 rotates in the direction of the arrow 5020, causing the lubricant to flow in the direction of the arrow 5022.

In operation, a foreign particle that enters the central channel 5004 from the lubricant supply channel 5008 is directed toward the curved channels 5012-5018 by the flow of the lubricant. When the foreign particle enters one of the curved channels 5012-5018, the rotation of the pin 5002 directs the lubricant, and thus the foreign particle, away from an interface between the pin 5002 and a roller. The low entry angle of the curved channels 5012-5018 directs the foreign particle to flow into the curved channels 5012-5018, and the curve of the curved channels 5012-5018 slows the flow of lubricant along the curved channels 5012-5018 so as to maintain a steady lubricant film and pressure between the pin 5002 and the roller.

FIG. 51 is an illustration of a follower lever assembly 5102 with a system of intersecting channels, according to a particular embodiment. The follower lever assembly 5102 includes an inlet channel 5104 that directs lubricant into the follower lever assembly 5102. At an intersection 5108, the inlet channel 5104 is in fluid communication with a lubricant supply channel 5122 that extends from the inlet channel 5104 to a socket 5110. Lubricant flows from the socket 5110 to an interface 5116 between a follower roller 5112 and a pin 5114. The inlet channel 5104 is also in fluid communication with a trap channel 5106 at the intersection 5108. The trap channel 5106 includes a plug 5118 and a weep hole 5120. The weep hole 5120 is sized to allow a slow, continuous flow of lubricant toward the plug 5118 while providing enough pressure to direct most of the lubricant toward the lubricant supply channel 5122. Foreign particles located in the lubricant are directed into the trap channel 5106 and into the plug 5118. Turbulence in the lubricant flow at the intersection 5108 prevents the foreign particles from exiting the weep hole 5120. During regular maintenance, the plug 5118 can be removed from the trap channel 5106 to remove the foreign particles from the plug 5118.

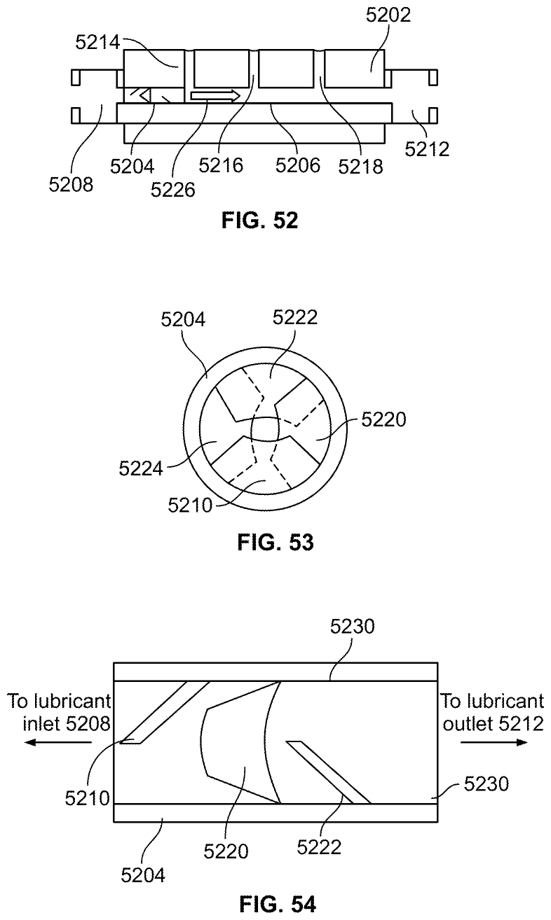

FIGS. 52-54 are illustrations of various views of a follower shaft 5202 with an insert 5204, according to a particular embodiment. The follower shaft 5202 includes a lubricant supply channel 5206 extending from a lubricant inlet 5208 to a lubricant outlet 5212. The follower shaft 5202 also includes a first channel 5214, a second channel 5216, and a third channel 5218 (collectively referred to herein as “channels 5214-5218”). The channels 5214-5218 direct lubricant from the lubricant supply channel 5206 to a follower lever (not shown).

The insert 5204 is inserted into the lubricant supply channel 5206 near the lubricant inlet 5208. In some embodiments, the lubricant supply channel 5206 has a cross-sectional shape that is substantially circular. Accordingly, and as shown in FIG. 53, the insert 5204 has a cross-sectional shape that is substantially circular to match the cross-sectional shape of the lubricant supply channel. The insert 5204 includes a first diverter 5210, a second diverter 5220, a third diverter 5222, and a fourth diverter 5224. The first diverter 5210 extends from an inner diameter 5230 of the insert 5204 and is angled toward the lubricant inlet 5208. The third diverter 5222 extends from the inner diameter of the insert 5204 and is positioned opposite the first diverter 5210 and downstream of the first diverter 5210 (e.g., the third diverter 5222 is located closer to the lubricant outlet 5212 than the first diverter 5210). The third diverter is also angled toward the lubricant inlet 5208. The second diverter 5220 extends from the inner diameter of the insert 5204 and is positioned between the first diverter 5210 and the third diverter 5222. The second diverter 5220 is also positioned approximately 90 degrees from the first diverter 5210 and the third diverter 5222 along the inner diameter of the insert 5204. For example, the second diverter 5220 is positioned on the inner diameter of the insert 5204 such that an axis extending from a central portion of the second diverter 5220 through the center of the circular cross-sectional shape of the insert 5204 is approximately ninety degrees from an axis extending from a central portion of the first diverter 5210 through the center of the circular cross-sectional shape of the insert 5204. The second diverter 5220 can be positioned in a clockwise or counterclockwise direction from the first diverter 5210. Furthermore, the third diverter 5222 is positioned on the inner diameter of the insert 5204 such that an axis extending from a central portion of the third diverter 5222 through the center of the circular cross-sectional shape of the insert 5204 is approximately ninety degrees from the axis extending from the central portion of the second diverter 5220 through the center of the cross-sectional shape of the insert 5204. The third diverter 5222 is positioned along the same direction as the second diverter 5220 (e.g, if the second diverter 5220 is positioned in a clockwise direction from the first diverter 5210, the third diverter 5222 is positioned in a clockwise direction from the second diverter 5220). Accordingly, the third diverter 5222 is positioned approximately opposite the first diverter 5210. The fourth diverter 5224 extends from the inner diameter of the insert 5204 and is positioned downstream from the third diverter 5222 and opposite the second diverter 5220. Arranged in the manner described, the first diverter 5210, the second diverter 5220, the third diverter 5222, and the fourth diverter 5224 create a tortuous path for a foreign particle located within the lubricant. As lubricant flows through the lubricant supply channel 5206, foreign particles are trapped by one or more of the first diverter 5210, the second diverter 5220, the third diverter 5222, and the fourth diverter 5224. Accordingly, the insert 5204 prevents foreign particles from being directed to other components in an engine. In various embodiments, the insert 5204 can be configured in a wide variety of ways to prevent foreign particles from being directed to other components. For example, the insert 5204 can include more or fewer diverters than described above. Additionally, the diverters can be positioned in any type of configuration that is effective (e.g., the diverters can be linearly positioned closer together or farther apart than described, the diverters can be angularly positioned closer together or farther apart than described, etc.).

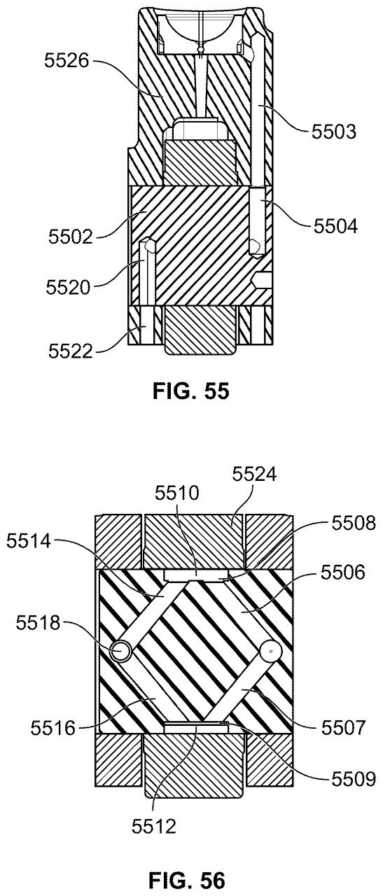

FIGS. 55-56 are illustrations of various views of a pin 5502 with an inlet lubricant supply path 5503 and an outlet 5518, according to a particular embodiment. The lubricant supply path 5503 directs lubricant to the pin 5502 via a pin inlet channel 5504. When the lubricant enters the pin 5502, the lubricant is directed through a first inlet channel 5506 and a second inlet channel 5507. The first inlet channel 5506 directs the lubricant to a first central channel 5510, and the second inlet channel 5507 directs the lubricant to a second central channel 5512. The first central channel 5510 and the second central channel 5512 are recessed portions of the pin 5502 that extend along a portion of an outer diameter of the pin 5502 such that lubricant fills a space between bottom portions of the first central channel 5510 and the second central channel 5512 and lubricates an interface between the pin 5502 and a roller 5524.

Lubricant is directed from the first central channel 5510 to a first debris channel 5514, and lubricant is also directed from the second central channel 5512 to a second debris channel 5516. The first debris channel 5514 and the second debris channel 5516 are smaller in diameter than the first inlet channel 5506 and the second inlet channel 5507. The difference in size provides a differential pressure which ensures lubricant is supplied to the interface between the pin 5502 and the roller 5524. The differential pressure also allows debris (e.g., foreign particles) to exit through the outlet 5518 without entering the interface between the pin 5502 and the roller 5524. The first debris channel 5514 and the second debris channel 5516 converge at the outlet 5518. The outlet 5518 directs lubricant to a passage 5520 in the pin 5502, and the passage 5520 directs lubricant to an exit passage 5522 located in a follower lever 5526.

In operation, when lubricant containing foreign particles enters the first central channel 5510 and the second central channel 5512, the foreign particles are directed to the first debris channel 5514 and the second debris channel 5516 such that the foreign particles eventually exit the system via the exit passage 5522 to prevent the foreign particles from contacting other components of the system.

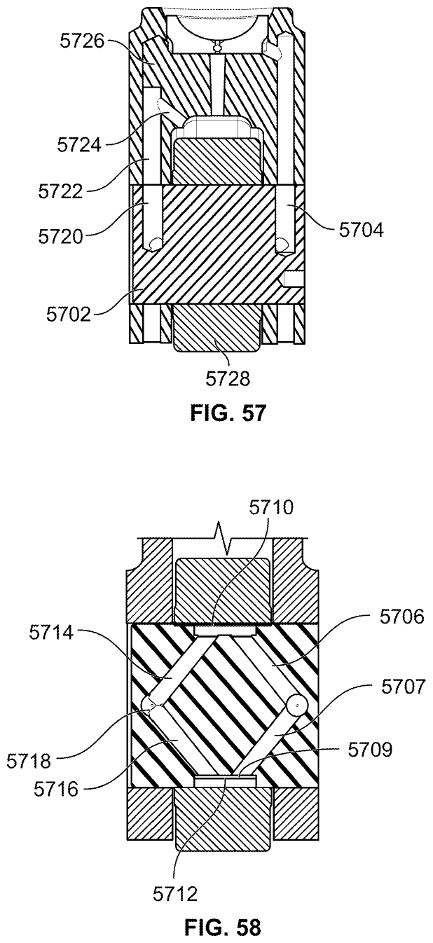

FIGS. 57-58 are illustrations of various views another pin 5702 with an inlet lubricant supply path 5704 and an outlet 5718, according to a particular embodiment. The inlet lubricant supply path 5704 directs lubricant to the pin 5702. When the lubricant enters the pin 5702, the lubricant is directed through a first inlet channel 5706 or a second inlet channel 5707. The first inlet channel 5706 directs the lubricant to a first central channel 5710, and the second inlet channel 5707 directs the lubricant to a second central channel 5712. The first central channel 5710 and the second central channel 5712 are recessed portions of the pin 5702 that extend along a portion of an outer diameter of the pin 5702 such that lubricant fills a space between bottom portions of the first central channel 5710 and the second central channel 5712 and lubricates an interface between the pin 5702 and a roller 5728.

Lubricant is directed from the first central channel 5710 to a first debris channel 5714, and lubricant is also directed from the second central channel 5712 to a second debris channel 5716. The first debris channel 5714 and the second debris channel 5716 are smaller in diameter than the first inlet channel 5706 and the second inlet channel 5707. The difference in size provides a pressure differential that assures sufficient lubricant remains in the first central channel 5710 and the second central channel 5712 for lubrication. The first debris channel 5714 and the second debris channel 5716 meet at the outlet 5718. The outlet 5718 directs lubricant (and any foreign particles within the lubricant) to a passage 5720 in the pin 5502, and the passage 5720 directs lubricant to a channel 5722 located in a follower lever 5726. Lubricant is then directed from the channel 5722 to an exit passage 5724, where the lubricant is directed to an outer surface of a roller 5728.

In operation, when lubricant containing foreign particles enters the first central channel 5710 and the second central channel 5712, the foreign particles are directed to the first debris channel 5714 and the second debris channel 5716 such that the foreign particles eventually exit the system via the exit passage 5724 to prevent the foreign particles from contacting other components of the system.

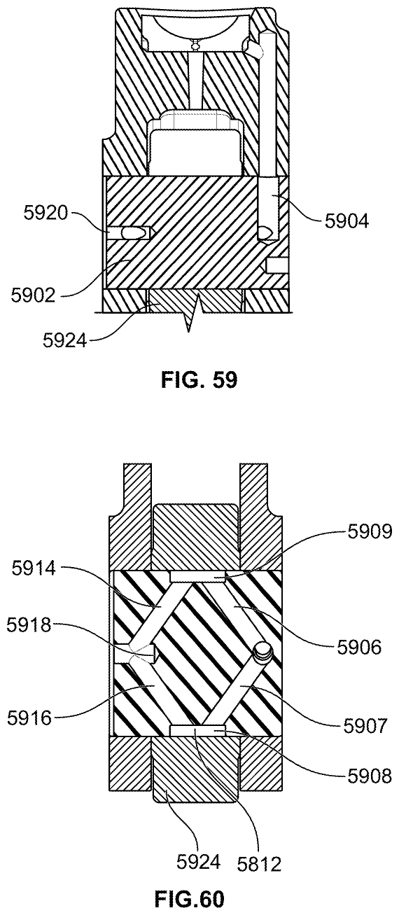

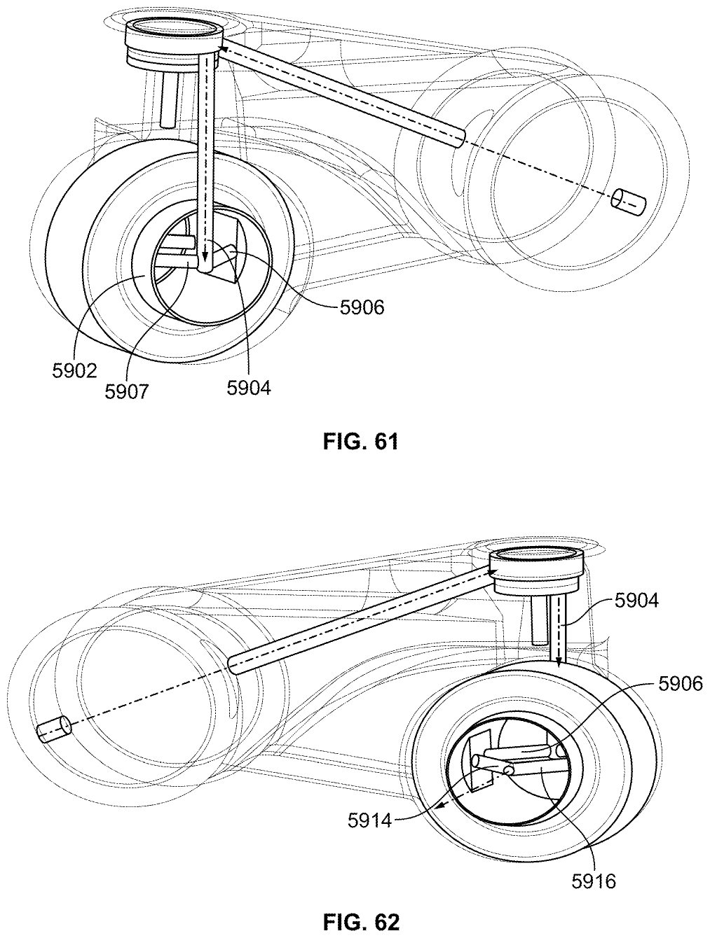

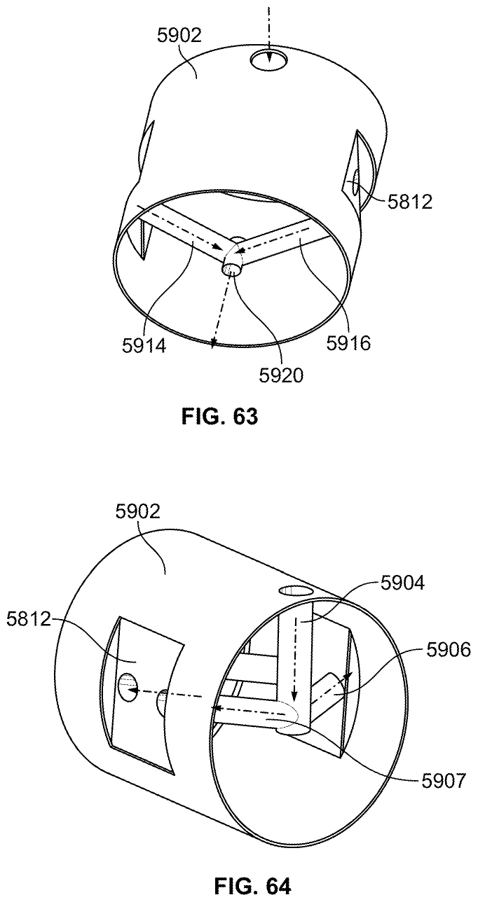

FIGS. 59-64 are illustrations of various views of yet another pin 5902 with an inlet lubricant supply path 5904 and an outlet 5918, according to a particular embodiment. The inlet lubricant supply path 5904 directs lubricant to the pin 5902. When the lubricant enters the pin 5902, the lubricant is directed through a first inlet channel 5906 or a second inlet channel 5907. The first inlet channel 5906 directs the lubricant to a first central channel 5910, and the second inlet channel 5907 directs the lubricant to a second central channel 5912. The first central channel 5910 and the second central channel 5912 are recessed portions of the pin 5902 that extend along a portion of an outer diameter of the pin 5902 such that lubricant fills a space between bottom portions of the first central channel 5910 and the second central channel 5912 and lubricates an interface between the pin 5902 and a roller 5924.

Lubricant is directed from the first central channel 5910 to a first debris channel 5914, and lubricant is also directed from the second central channel 5912 to a second debris channel 5916. The first debris channel 5914 and the second debris channel 5916 are smaller in diameter than the first inlet channel 5906 and the second inlet channel 5907. The difference in size provides a pressure differential that assures sufficient lubricant remains in the first central channel 5910 and the second central channel 5912 for lubrication. The first debris channel 5914 and the second debris channel 5916 meet at an outlet 5918. The outlet 5918 directs lubricant to an exit passage 5920 in the pin 5502, where the lubricant is directed away from the pin 5902.

In operation, when lubricant containing foreign particles enters the first central channel 5910 and the second central channel 5912, the foreign particles are directed to the first debris channel 5914 and the second debris channel 5916 such that the foreign particles eventually exit the system via the exit passage 5920 to prevent the foreign particles from contacting other components of the system.

### IV. Construction of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the term “substantially,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language a “portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative embodiments. Other substitutions, modifications, changes, and omissions may also be made in the design, operating conditions and arrangement of the various exemplary embodiments without departing from the scope of the present invention.

What is claimed is:

1. A system, comprising:
a follower lever;
a follower roller rotatably coupled to the follower lever; and
a pin rotatably coupled to the follower roller, the pin comprising:
a first outer portion including a first diameter;
a second outer portion including a second diameter; and
a central portion positioned between the first outer portion and the second outer portion, the central portion including a third diameter, the third diameter being smaller than the first diameter and the second diameter.

2. The system of claim 1, wherein the central portion extends entirely around a circumference of the pin.

3. The system of claim 2, further comprising one or more channels positioned in the first outer portion and the second outer portion, the one or more channels configured to direct lubricant away from the central portion as the pin rotates.

4. The system of claim 3, wherein the central portion defines a lubricant supply channel, the lubricant supply channel configured to provide the lubricant to the central portion.

5. The system of claim 1, wherein the central portion includes a first endpoint and a second endpoint positioned so as to prevent the central portion from extending entirely around a circumference of the pin.

6. The system of claim 5, wherein the first endpoint and the second endpoint define an unmachined portion of the pin, the unmachined portion of the pin positioned between the first outer portion and the second outer portion.

7. The system of claim 6, wherein the central portion defines a lubricant supply channel, the lubricant supply channel configured to provide lubricant to the central portion.

8. A system, comprising:
a follower lever;
a follower roller rotatably coupled to the follower lever, the follower roller comprising;
an inner surface defining an inner diameter and a first channel, the first channel extending into the inner surface and terminating at a first outlet, the first channel configured to direct a lubricant away from the inner surface; and
an outer surface defining an outer diameter; and
a pin rotatably coupled to the follower roller and sized to fit within the inner diameter.

9. The system of claim 8, wherein the first channel terminates at a second outlet positioned opposite the first outlet.

10. The system of claim 8, wherein the first outlet extends through the outer surface and the first channel is configured to direct the lubricant away from the outer surface.

11. The system of claim 8, wherein the first outlet is positioned between the inner surface and the outer surface and the first channel is configured to capture the lubricant that is directed away from the inner surface.

12. The system of claim 9, further comprising a second channel defined by the inner surface, the second channel extending into the inner surface and terminating at a third outlet, the second channel configured to direct the lubricant away from the inner surface.

13. The system of claim 12, wherein the second channel terminates at a fourth outlet positioned opposite the third outlet.

14. The system of claim 12, wherein the third outlet extends through the outer surface and the second channel is configured to direct the lubricant away from the outer surface.

15. The system of claim 14, wherein the third outlet is positioned between the inner surface and the outer surface and the second channel is configured to capture the lubricant that is directed away from the inner surface.

16. A system, comprising:
a follower lever;
a follower shaft fluidly coupled to the follower lever, the follower shaft comprising:
a lubricant supply channel extending from a lubricant inlet to a lubricant outlet;
an insert positioned within the lubricant supply channel, the insert comprising a first diverter coupled to the lubricant supply channel and extending toward the lubricant inlet, the first diverter configured to trap particles positioned within a lubricant flowing through the lubricant supply channel;
a follower roller rotatably coupled to the follower lever; and
a pin rotatably coupled to the follower roller.

17. The system of claim 16, further comprising a second diverter coupled to the lubricant supply channel and extending toward the lubricant inlet, the second diverter positioned downstream from the first diverter and configured to trap particles positioned within the lubricant.

18. The system of claim 17, further comprising a third diverter coupled to the lubricant supply channel and extending toward the lubricant inlet, the third diverter positioned downstream from the second diverter and configured to trap particles positioned within the lubricant.

19. The system of claim 18, wherein the second diverter is positioned approximately ninety degrees from the first diverter, and the third diverter is positioned approximately ninety degrees from the second diverter.

20. The system of claim 19, further comprising a fourth diverter coupled to the lubricant supply channel and extending toward the lubricant inlet, the fourth diverter positioned downstream from the third diverter and opposite the second diverter, the fourth diverter configured to trap particles positioned within the lubricant.
